(19) United States
(12) Patent Application Publication
(10) Pub. No.: US 2026/0023311 A1
(43) Pub. Date: Jan. 22, 2026

(54) PROJECTION DISPLAY DEVICE

(71) Applicant: Sharp NEC Display Solutions, Ltd., Tokyo (JP)

(72) Inventor: Isao TAKAHASHI, Tokyo (JP)

(21) Appl. No.: 19/342,213

(22) Filed: Sep. 26, 2025

Related U.S. Application Data
(63) Continuation of application No. PCT/JP2023/013798, filed on Apr. 3, 2023.

(51) Int. Cl. G03B 21/20

(52) U.S. Cl. CPC G03B 21/204; G03B 21/2053; G03B 21/2066

(57) ABSTRACT

A projection display device includes a light source, a reflection mirror that has a reflecting surface reflecting light emitted from the light source in a predetermined direction, a light receiving sensor that detects an output of the light having passed through the reflection mirror, and an opening member that is provided between the reflection mirror and the light receiving sensor and has an opening through which the light having passed through the reflection mirror passes. The opening member is positioned on an optical axis of the light that passes through the reflection mirror. The opening of the opening member is positioned to be misaligned from the optical axis of the light that passes through the reflection mirror.

### TECHNICAL FIELD

The present invention relates to a projection display device.

### BACKGROUND ART

Patent Document 1 discloses a projection display device (projector) that separates light (white light) emitted from a light source into RGB (red, green, blue) color light, modulates each of these three types of color light to form three types of image light, and synthesizes and projects the three types of image light. In the projection display device disclosed in Patent Document 1, light emitted from the light source is reflected by a reflection mirror before being separated into the three types of color light. In addition, the projection display device disclosed in Patent Document 1 includes a light receiving sensor that detects leakage light that has passed through the reflection mirror. In the projection display device disclosed in Patent Document 1, the amount of light from the light source is controlled on the basis of detection results of the light receiving sensor to keep the amount of light from the light source constant.

### CITATION LIST

### Patent Document

Patent Document 1: Japanese Unexamined Patent Application, First Publication No. 2005-181591

### SUMMARY OF INVENTION

### Technical Problem

Incidentally, some projection display devices in recent years have used semiconductor lasers as light sources, the semiconductor lasers being expected to have a longer life span, a wider color reproduction range, and higher light utilization efficiency than lamps. However, light emitted from a light source using a semiconductor laser is stronger than that of a lamp, and thus even leakage light that passes through a reflection mirror can cause saturation of a light receiving sensor, which may lead to errors when controlling the amount of light from the light source.

It is also conceivable to prevent saturation of a light receiving sensor by providing a neutral density filter or an integrating sphere between the reflection mirror and the light receiving sensor. However, neutral density filters and integrating spheres are expensive and large in volume. For this reason, there is a problem in that projection display devices become expensive and large in size.

The present invention has been made in consideration of the above-mentioned circumstances, and an object thereof is to provide a projection display device that is capable of inexpensively attenuating light emitted from a light source and directed toward a light receiving sensor while preventing the projection display device from becoming larger in size.

### Solution to Problem

One aspect of the present invention is a projection display device including a light source, a reflection mirror that has a reflecting surface reflecting light emitted from the light source in a predetermined direction, a light receiving sensor that detects an output of the light having passed through the reflection mirror, and an opening member that is provided between the reflection mirror and the light receiving sensor and has an opening through which the light having passed through the reflection mirror passes. The opening member is positioned on an optical axis of the light that passes through the reflection mirror. The opening of the opening member is positioned to be misaligned from the optical axis of the light that passes through the reflection mirror.

### Advantageous Effects of Invention

According to the present invention, it is possible to inexpensively attenuate light emitted from a light source and directed toward a light receiving sensor while preventing a projection display device from becoming larger in size.

### BRIEF DESCRIPTION OF DRAWINGS

FIG. 1 A schematic diagram showing a projection display device according to a first embodiment of the present invention.

FIG. 2 A plan view showing a light receiving sensor provided in the projection display device shown in FIG. 1.

FIG. 3 A plan view showing an opening member provided in the projection display device shown in FIG. 1.

FIG. 4 A plan view showing a modification example of the opening member shown in FIG. 3.

FIG. 5 A plan view showing an opening member provided in a projection display device according to a second embodiment of the present invention.

### DESCRIPTION OF EMBODIMENTS

### First Embodiment

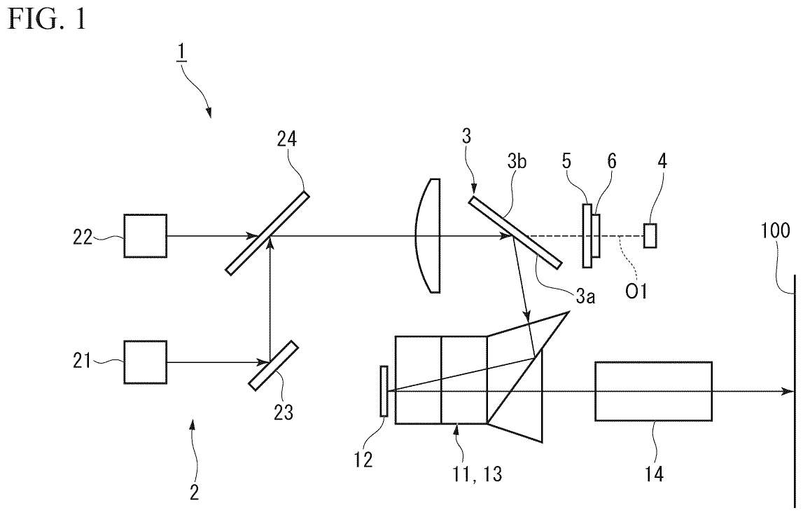

A first embodiment of the present invention will be described below with reference to FIGS. 1 to 3.

As shown in FIG. 1, a projection display device 1 (projector) according to this embodiment is a device that projects image light (image) onto a display surface 100 such as a screen. The projection display device 1 includes a light source 2, a reflection mirror 3, a light receiving sensor 4, a member with an opening 5, and a diffusion member 6. In addition, the projection display device 1 also includes a color light separation unit 11, a light modulation unit 12, a color light synthesis unit 13, and a projection unit 14.

The light source 2 emits white light (hereinafter, also simply referred to as “light”). The light source 2 may emit light of other colors, for example. A specific configuration of the light source 2 may be arbitrary. The light source 2 in this embodiment is configured using a semiconductor laser. The light source 2 shown in FIG. 1 includes blue semiconductor lasers 21 and 22, a yellow phosphor 23, and a dichroic mirror 24.

The blue semiconductor lasers 21 and 22 emit blue light. The light source 2 includes two blue semiconductor lasers 21 and 22. The first blue semiconductor laser 21 emits light toward the yellow phosphor 23. The second blue semiconductor laser 22 emits light toward the dichroic mirror 24. The light source 2 may include, for example, one blue semiconductor laser, a portion of the blue light emitted from one blue semiconductor laser may be emitted toward the yellow phosphor 23, and the remaining portion of the blue light may be emitted toward the dichroic mirror 24.

The yellow phosphor 23 emits yellow light when irradiated with blue light from the first blue semiconductor laser 21. The yellow light includes red and green light. The dichroic mirror 24 transmits the blue light emitted from the second blue semiconductor laser 22 and reflects the yellow light emitted from the yellow phosphor 23 in the same direction as the blue light. Thereby, the blue light and the yellow light are combined to generate white light. A configuration for generating and emitting white light using blue light and yellow light is not limited to one using the dichroic mirror 24 and may be any configuration.

The reflection mirror 3 has a reflecting surface 3a that reflects the white light emitted from the light source 2 in a predetermined direction. The white light reflected by the reflection mirror 3 is directed toward the color light separation unit 11, which will be described later.

The color light separation unit 11 separates the white light reflected by the reflection mirror 3 into three types of color light: red light (first color light), green light (second color light), and blue light (third color light). The light modulation unit 12 modulates each of the separated three types of color light. The color light synthesis unit 13 synthesizes the plurality of types of color light modulated by the light modulation unit 12. Specific configurations of the color light separation unit 11, the light modulation unit 12, and the color light synthesis unit 13 may be arbitrary.

The color light separation unit 11 and the color light synthesis unit 13 shown in FIG. 1 are configured with a color light separation synthesis prism (Phillips prism). The color light separation synthesis prism separates white light reflected by the reflection mirror 3 into three types of color light, and directs these three types of color light from three different incident/emission faces toward the light modulation unit 12. The color light separation synthesis prism also synthesizes the three types of color light that are modulated by the light modulation unit 12 and are then incident on the above-mentioned incident/emission faces at a predetermined incidence angle, and outputs the synthesized light (synthesized light) toward the projection unit 14.

Although only one light modulation unit 12 is shown in FIG. 1, three light modulation units are actually provided to correspond to the three incident/emission faces of the color light separation synthesis prism. The three light modulation units 12 respectively modulate the three types of color light emitted from the three incident/emission faces of the color light separation synthesis prism. The light modulation unit 12 shown in FIG. 1 is a reflective light bulb such as a DLP, but it may also be, for example, a liquid crystal panel.

The projection unit 14 enlarges the synthesized light emitted from the color light synthesis unit 13 (color light separation synthesis prism) and projects it onto the display surface 100. The projection unit 14 may be, for example, a projection lens.

The light receiving sensor 4 is disposed on a back surface 3b of the reflection mirror 3, which faces the opposite side to the reflecting surface 3a. The light receiving sensor 4 detects the output of light that has passed through the reflection mirror 3. The light receiving sensor 4 is preferably disposed on an optical axis O1 of light that passes through the reflection mirror 3, but may be positioned to be misaligned from the optical axis O1, taking into account the diffraction of light by the opening member 5 to be described later.

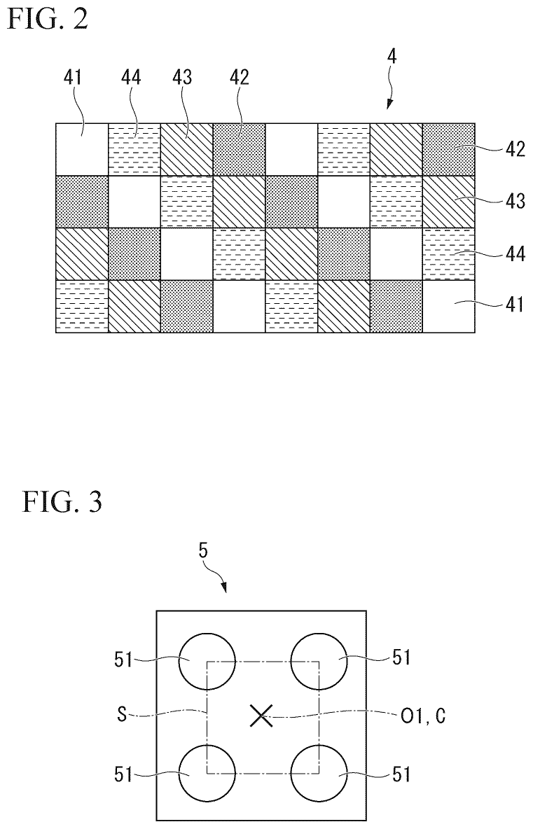

As shown in FIG. 2, the light receiving sensor 4 in this embodiment includes an illuminance sensor unit 41 and three (multiple) types of color light sensors 42, 43, and 44. In FIG. 2, the illuminance sensor unit 41 is shown in white, and the three types of color light sensors 42, 43, and 44 are shown with different patterns.

The illuminance sensor unit 41 detects the output of white light. The three types of color light sensors 42, 43, and 44 respectively detect the outputs of the three types of color light (red light, green light, and blue light) that configure the white light.

The three types of color light sensors 42, 43, 44 include a red light sensor unit 42 that detects the output of red light, a green light sensor unit 43 that detects the output of green light, and a blue light sensor unit 44 that detects the output of blue light. The blue light sensor unit 44 detects the output of blue light emitted from the second blue semiconductor laser 22 of the light source 2. In addition, the red light sensor unit 42 and the green light sensor unit 43 substantially detect the output of yellow light (red light and green light) emitted from the yellow phosphor 23 of the light source 2.

The light receiving sensor 4 shown in FIG. 2 includes a plurality of illuminance sensor units 41, a plurality of red light sensor units 42, a plurality of green light sensor units 43, and a plurality of blue light sensor units 44. In addition, the number of illuminance sensor units 41, the number of red light sensor units 42, the number of green light sensor units 43, and the number of blue light sensor units 44 are equal to each other. Furthermore, the illuminance sensor units 41, the red light sensor units 42, the green light sensor units 43, and the blue light sensor units 44 are arranged to be distributed substantially evenly, that is, not to be biased.

As shown in FIG. 1, the opening member 5 is provided between the reflection mirror 3 and the light receiving sensor 4. The opening member 5 is positioned at a distance from each of the reflection mirror 3 and the light receiving sensor 4. A gap between the opening member 5 and the light receiving sensor 4 may be, for example, several centimeters to several tens of centimeters.

As shown in FIG. 3, the opening member 5 has an opening 51 through which light having passed through the reflection mirror 3 passes. The opening 51 is formed by penetrating the opening member 5. The penetration direction of the opening 51 is in the direction of the optical axis O1 of the light having passed through the reflection mirror 3. In FIG. 3, the direction of the optical axis O1 is perpendicular to the paper surface. In this embodiment, the shape of the opening 51 as viewed from the direction of the optical axis O1 is a circle (perfect circle).

The opening member 5 is positioned on the optical axis O1 of the light having passed through the reflection mirror 3. The opening 51 of the opening member 5 is positioned to be misaligned from the optical axis O1.

The opening member 5 in this embodiment has a plurality of openings 51. The plurality of openings 51 are positioned to surround the optical axis O1. The opening member 5 is disposed such that the center of gravity C of the shape S drawn by connecting the centers of the plurality of openings 51 is aligned with the optical axis O1. The center of gravity C may coincide with the optical axis O1 as shown in FIG. 3, but, for example, it may not coincide with the optical axis O1.

In FIG. 3, the number of openings 51 is four, and the shape S drawn by connecting the centers of the four openings 51 is a square. The centers of the four openings 51 each correspond to a corner of the square. The number of openings 51 may be arbitrary, and the shape S drawn by connecting the centers of the plurality of openings 51 may be another regular polygon such as an equilateral triangle or a regular pentagon.

The size of the opening member 5 as viewed from the direction of the optical axis O1 may be set such that light having passed through the reflection mirror 3 does not pass through the outside of the opening member 5 to reach the light receiving sensor 4, and such that the light having passed through the reflection mirror 3 passes through the opening 51 of the opening member 5 to reach the light receiving sensor 4.

The opening member 5 may be, for example, a plate material with the opening 51 penetrating in the plate thickness direction, but is not limited thereto. The opening 51 may also be blocked by a member through which light passes.

As shown in FIG. 1, the diffusion member 6 is provided between the opening member 5 and the light receiving sensor 4. The diffusion member 6 diffuses (or scatters) the light that passes through the opening 51 of the opening member 5, directing it toward the light receiving sensor 4. In FIG. 1, the diffusion member 6 is disposed to overlap the opening member 5, but it may be disposed at a distance from the opening member 5, for example.

The projection display device 1 also includes a control unit (not shown). The control unit controls the operation of the light source 2 on the basis of detection results obtained by the light receiving sensor 4. For example, the control unit may control the output of light (white light) emitted from the light source 2 so as to keep the brightness of the light emitted from the light source 2 constant on the basis of the output of the light (white light) detected by the light receiving sensor 4. For example, the control unit may also control the output of a plurality of types of color light so as to prevent deviation in the chromaticity of the light emitted from the light source 2 on the basis of the output of the plurality of types of color light detected respectively by the plurality of color light sensors 42, 43, and 44 of the light receiving sensor 4. In this embodiment, the control unit may control the output of the plurality of types of color light by controlling the output of blue light emitted from the blue semiconductor lasers 21 and 22 that configure the light source 2.

As described above, the projection display device 1 in this embodiment includes the opening member 5 that is provided between the reflection mirror 3 and the light receiving sensor 4 and includes the opening 51 through which the light having passed through the reflection mirror 3 passes. The opening member 5 is located on the optical axis O1 of the light having passed through the reflection mirror 3. The opening 51 of the opening member 5 is also positioned to be misaligned from the optical axis O1 of the light having passed through the reflection mirror 3. For this reason, the light having passed through the reflection mirror 3 is diffracted at the opening 51 of the opening member 5. Thereby, the light having passed through the reflection mirror 3 is further attenuated by the opening member 5 and then reaches the light receiving sensor 4. Such an opening member 5 can be made smaller in volume than a neutral density filter or an integrating sphere, and can be manufactured inexpensively. Thus, the light emitted from the light source 2 and directed toward the light receiving sensor 4 can be attenuated inexpensively while preventing the projection display device 1 from becoming larger in size.

Furthermore, in the projection display device 1 of this embodiment, the opening member 5 has a plurality of openings 51 mentioned above. Thereby, it is possible to improve the robustness of the positions of the openings 51 of the opening member 5 with respect to the light receiving sensor 4.

Furthermore, in the projection display device 1 of this embodiment, the plurality of openings 51 of the opening member 5 are positioned to surround the optical axis O1. Thereby, it is possible to suppress variations in the illuminance of light incident on the light receiving sensor 4 even when the position of the opening member 5 with respect to the optical axis O1 is shifted. Thus, the illuminance of light incident on the light receiving sensor 4 can be kept at an appropriate level.

Further, in the projection display device 1 of this embodiment, the opening member 5 is disposed such that the center of gravity C of the shape S drawn by connecting the centers of the plurality of openings 51 is aligned with the optical axis O1 of the light having passed through the reflection mirror 3 as viewed from the direction of the optical axis O1. Thereby, it is possible to effectively prevent the intensity of the light diffracted (diffracted light) at each opening 51 of the opening member 5 from varying among the plurality of openings 51.

Further, in the projection display device 1 of this embodiment, the shape S drawn by connecting the centers of the plurality of openings 51 is a regular polygon. For this reason, it is possible to reduce a difference in distance from the center of gravity C of the regular polygon to each of the openings 51. Thereby, it is possible to further effectively prevent the intensity of the light diffracted (diffracted light) at each opening 51 of the opening member 5 from varying among the plurality of openings 51 in a state where the opening member 5 is disposed such that the center of gravity C of the polygon is aligned with the optical axis O1.

Furthermore, in the projection display device 1 of this embodiment, the plurality of openings 51 are disposed only at the corners of the regular polygon described above. For this reason, there is no difference in distance from the center of gravity C of the regular polygon to each of the openings 51. Thereby, it is possible to further effectively prevent the intensity of the diffracted light diffracted at each opening 51 of the opening member 5 from varying among the plurality of openings 51 in a state where the opening member 5 is disposed such that the center of gravity C of the regular polygon is aligned with the optical axis O1.

In addition, the projection display device 1 of this embodiment includes the diffusion member 6 that diffuses light having passed through the opening 51 of the opening member 5 and directs it toward the light receiving sensor 4. For this reason, diffracted light having passed through the reflection mirror 3 and diffracted at the opening 51 of the opening member 5 is diffused by the diffusion member 6 and then directed toward the light receiving sensor 4. Thereby, the light having passed through the opening member 5 can be further attenuated by the diffusion member 6 and then reach the light receiving sensor 4.

Further, in the projection display device 1 of this embodiment, the plurality of color light sensors 42, 43, and 44 of the light receiving sensor 4 detect the outputs of a plurality of types of color light that configure white light emitted from the light source 2. For this reason, even when differences occur in the outputs (brightnesses) of the plurality of types of color light on the basis of differences in deterioration of the plurality of types of color light caused by using the light source 2 for a long time, the outputs of the plurality of types of color light can be adjusted on the basis of the detection results obtained by the light receiving sensor 4 so that the chromaticity of the light (white light) emitted from the light source 2 does not deviate.

Furthermore, in the light source 2 of the projection display device 1 in this embodiment, white light is generated and emitted by blue light emitted from the blue semiconductor lasers 21 and 22 and yellow light emitted from the yellow phosphor 23 by being irradiated with a portion of the blue light. The light receiving sensor 4 then detects the output of the blue light and the output of the yellow light included in the white light. For this reason, even when a difference occurs between the output (brightness) of the blue light and the output of the yellow light on the basis of the differences in deterioration between the blue light and the yellow light caused by using the light source 2 for a long time, the output of the blue light emitted from the blue semiconductor lasers 21 and 22 can be adjusted on the basis of the detection results obtained by the light receiving sensor 4 so that the chromaticity of the light (white light) emitted from the light source 2 does not deviate.

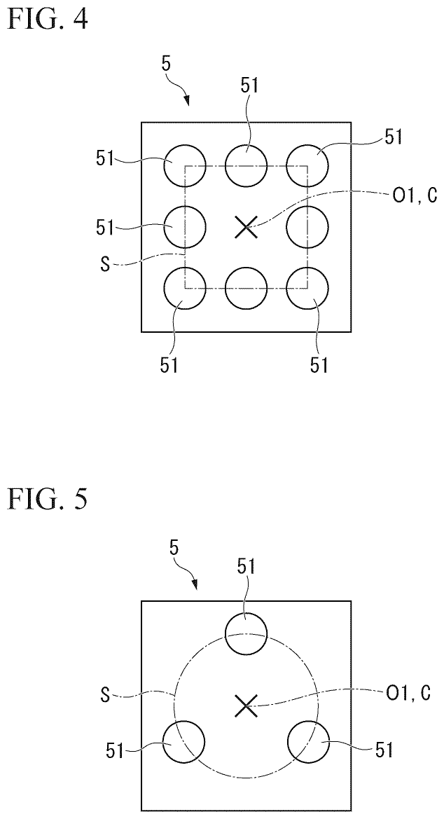

In the first embodiment, the shape S drawn by connecting the centers of the plurality of openings 51 is not limited to a regular polygon, but may be any polygon. Furthermore, the openings 51 are not limited to being disposed only at the corners of the polygon, but may be disposed not only at the corners of the polygon but also along the sides of the polygon, as shown in FIG. 4, for example. Even with such a configuration, the same effects as those of the first embodiment described above can be exhibited. However, when the openings 51 are disposed along the sides of the polygon, the amount of light passing through the plurality of openings 51 of the opening member 5 is greater than when the openings 51 are disposed only at the corners of the polygon.

### Second Embodiment

Next, a second embodiment of the present invention will be described with reference to FIG. 5. In the second embodiment, the same components as those in the first embodiment are given the same reference numerals, and the description thereof will be omitted.

The projection display device in the second embodiment is configured in the same manner as the projection display device 1 in the first embodiment, except for the aspect of the opening member 5. As shown in FIG. 5, the opening member 5 in the second embodiment has a plurality of openings 51, as in the first embodiment. In view of the direction of the optical axis O1, the plurality of openings 51 are disposed concentrically. That is, the shape S drawn by connecting the centers of the plurality of openings 51 is a circle (perfect circle). In addition, the plurality of openings 51 are arranged at equal intervals in the circumferential direction. The number of openings 51 is not limited to three as shown in FIG. 5, but, for example, may be two or more.

The opening member 5 is disposed such that the center of gravity C (center) of the circle is aligned with the optical axis O1, as in the first embodiment. The center of gravity C may be aligned with the optical axis O1 as shown in FIG. 5, but may not be aligned with the optical axis O1.

The projection display device in the second embodiment has the same effect as the first embodiment.

Further, in the projection display device of the second embodiment, the plurality of openings 51 of the opening member 5 are disposed concentrically and lined up at equal intervals in the circumferential direction. For this reason, there is no difference in distance from the center of gravity C of the circle drawn by connecting the centers of the plurality of openings 51 to each of the openings 51. Thereby, it is possible to further effectively prevent the intensity of the diffracted light diffracted at each opening 51 of the opening member 5 from varying among the plurality of openings 51 in a state where the opening member 5 is disposed such that the center of gravity C of the circle is aligned with the optical axis O1.

Although the embodiments of the present invention have been described above, the present invention is not limited to the above embodiments, and can be modified as appropriate within the scope of the present invention.

In the present invention, the shape of the opening 51 as viewed from the direction of the optical axis O1 is not limited to the circle (perfect circle) shown in FIGS. 2, 4, and 5, but may be any shape, such as an elliptical shape or a rectangular shape. In addition, the shape of the opening 51 may be the same among the plurality of openings 51 as shown in FIGS. 2, 4, and 5, but may also be different among the plurality of openings 51, for example. When a distance between the opening member and the light receiving sensor 4 is approximately several centimeters to several tens of centimeters, high-order diffracted light is not generated in accordance with the shape of the opening 51 even when the shape of the opening 51 varies as described above.

In the present invention, when the number of openings 51 of the opening member 5 is plural, the size of the opening 51 may be the same among the plurality of openings 51 as shown in FIGS. 3 to 5, or may be different among the plurality of openings 51, for example.

In the present invention, the light source 2 that emits white light may be configured with three types of semiconductor lasers that emit three types of color light, for example, RGB (red, green, blue).

In the present invention, the light receiving sensor 4 may include, for example, only the illuminance sensor unit 41, or may include only the color light sensors 42, 43, and 44.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1 Projection display device
2 Light source
3 Reflection mirror
3a Reflecting surface
3b Back surface
4 Light receiving sensor
5 Opening Member
6 Diffusion unit
21, 22 Blue semiconductor laser
23 Yellow phosphor
42, 43, 44 Color light sensor unit
51 Opening
C Center of gravity
O1 Optical axis

What is claimed is:

1. A projection display device comprising:
a light source;
a reflection mirror that has a reflecting surface configured to reflect, in a predetermined direction, an emitted light that has been emitted from the light source;
a light receiving sensor configured to detect a transmitted light that has passed through the reflection mirror; and
an opening member that has at least one opening through which the transmitted light pass, the opening member being placed between the reflection mirror and the light receiving sensor,
wherein the opening member is positioned on an optical axis of the transmitted light that has passed through the reflection mirror, and
wherein the at least one opening of the opening member is positioned to be misaligned from the optical axis of the transmitted light that has passed through the reflection mirror.

2. The projection display device according to claim 1, wherein the opening member has a plurality of openings.

3. The projection display device according to claim 2, wherein the plurality of openings are positioned to surround the optical axis of the transmitted light that has passed through the reflection mirror.

4. The projection display device according to claim 3, wherein the opening member is positioned such that a gravity center of a geometric shape which is drawn by connecting the centers of the plurality of openings is aligned with the optical axis of the transmitted light that has passed through the reflection mirror, in view of the direction of the optical axis of the transmitted light that has passed through the reflection mirror.

5. The projection display device according to claim 4, wherein the geometric shape drawn by connecting the centers of the plurality of openings is a regular polygon in view of the direction of the optical axis of the transmitted light that has passed through the reflection mirror.

6. The projection display device according to claim 4, wherein the plurality of openings are disposed concentrically at equal intervals in the circumferential direction in view of the direction of the optical axis of the transmitted light that has passed through the reflection mirror.

7. The projection display device according to claim 1, further comprising:
a diffusion member that is placed between the opening member and the light receiving sensor, the diffusion member being configured to diffuse the transmitted light that has passed through the at least one opening, and to direct a diffused light, which has been diffused, toward the light receiving sensor.

8. The projection display device according to claim 1,
wherein the light source is configured to emit a white light, and
wherein the light receiving sensor has a plurality of color light sensors that detect respective outputs of a plurality of component color lights that make up the white light.

9. The projection display device according to claim 1,
wherein the light source includes a blue semiconductor laser device configured to emit a blue light and a yellow phosphor that is capable of emitting a yellow light when the yellow phosphor is irradiated with a portion of the blue light, where the blue light and the yellow light make up a white light which is to be emitted from the light source, and
wherein the light receiving sensor is configured to detect the output of the blue light and the output of the yellow light included in the white light emitted from the light source.
